(19) United States
(12) Patent Application Publication
(10) Pub. No.: US 2005/0159919 A1
(43) Pub. Date: Jul. 21, 2005

(54) Method for measuring information in natural data

(75) Inventor: Robert Shaw Sneddon, Pasadena, CA (US)

Correspondence Address: Robert S. Sneddon, 595 North Garfield Apt. 6, Pasadena, CA, 91101, US

(73) Assignee: Sneddon & Associates Inc.

(21) Appl. No.: 11/016,703

(22) Filed: Dec. 17, 2004

Related U.S. Application Data
(60) Provisional application No. 60/529,944, filed on Dec. 17, 2003.

(51) Int. Cl. G06F 17/18

(52) U.S. Cl. 702/179

(57) ABSTRACT

A method for measuring an informational property of a data set. This data set can contain data which is not the product of intentionally defined informational symbols, such as electroencephalography (EEG) data. Instantiations of informational symbols are identified by the discontinuities and critical points (maxima, minima, saddle points) in the data. A fundamental informational property of each outcome is computed based on the data which represents each outcome. These outcomes are aggregated to produce a total informational value.

### CROSS-REFERENCE TO RELATED APPLICATIONS

This application claims the benefit of provisional patent application Ser. No. 60/529,944, filed 2003 Dec. 17 by the present inventor.

### BACKGROUND OF THE INVENTION

The field of this invention relates to data methods for the measuring and estimation of values related to information, entropy and complexity. Measuring the information contained in informational symbols is often a task one wants to accomplish. An important and often unstated assumption of any method for measuring an informational property of a data set is that in order to measure the information, we need to have a “dictionary” which tells use how information symbols are physically instantiated. This is best illustrated by an example. B, b, b, B, b, are all physical instantiations of the letter “b.” Yet each one is different. We call them the letter “b” but they are actually black ink on a white page. In terms of reflected light, they are depicted by a bright light level which rapidly changes to a low light level and then back to a bright light level. This pattern of light intensity changes how our brain reads the letter “b.” Our sensory system knows, without effort, how to interpret them as the letter “b.” Another example is our ability to understand the word “hello.” The physical data, changing sound frequencies and sound intensities which represent a particular instantiation of the word “hello,” are somehow related to this word in a manner which we instinctively know. Whatever that relationship, it is certainly not a one-to-one relationship. Instead, almost every time the word “hello” is spoken it has somewhat different sound frequencies and sound intensities.

Thus, a fundamental difficulty of measuring an informational value in a data set is partitioning the data into data sets where each data set contains the data which represents the physical instantiation of a single informational symbol, e.g., the light intensity data values which represent the letter “b,” or the sound intensity and frequency values which represent the word “hello.”

Even if we are able to accomplish this difficult problem, we traditionally have the difficult problem of deciding which of these data sets contain instantiations of the same informational symbol and which data sets contain data that represent a different informational symbol.

Often an informational measure, such as the Shannon information or the Tsallis information is measured by some variant of information symbol event probability estimation. Usually, this estimation is based on frequency counting. However, deciding what data represents what symbol is generally the product of guess work. For example, in neuroscience the voltage outputs of neuron, “spike trains,” are generally considered to represent information. However, the question of what portions of these spike trains represent a particular symbol and which ones represent different symbols is a fundamental difficulty. The “answer” to this problem is often an exercise in guess work. These guesses can be of the form “the average number of spikes in 100 milliseconds (ms)” or each spike that occurs at a different time interval represents something different. However, the real answer could be something much different, because these answers assume that all spikes are the same, they do not account for the actual structure of a particular spike.

The present invention shows how to take data which represents the physical instantiations of informational symbols and compute an informational value for those data, without having the dictionary which maps these physical instantiations to their respective symbols. It also shows how to do this without having to identify which physical instantiations represent the same symbol and which ones represent a different symbol. This provides a tremendous improvement over the prior art, because the prior art assumes, often implicitly, that we have that dictionary or an approximation thereof.

Moreover, the present invention shows how to treat any data set, as a data set which contains the outcomes of informational symbols. Normally one only looks at data which contains specifically defined symbols, such as words, as informational data. However, many if not all sorts of data can be viewed in this manner.

### SUMMARY

The ability to measure values related to the information contained in natural data is curbed by a fundamental problem; the inability to divide the data set into subsets such that each subset contains the outcome(s) of each different informative event.

The process of this invention begins with the use of a data set which is separated into data subsets at the points in the data set where the gradient of the data is equal to zero or is undefined; a discontinuity. This has the unanticipated result of separating the data set into event outcomes without knowing what the events are.

A value is computed for each of these subsets, for example the variance of each of these data subsets. These values are summed up and divided by a value computed from a plurality of data subsets, for example the total variance of the data set. This value is further analyzed, for example, it can be subtracted from one. These results in computing a value which is related to the information contained in the data set without the knowledge of what data subsets correspond to different occurrences of different informational events and which data subsets correspond to different occurrences of the same informational event. Furthermore, it results in computing this value without explicitly computing the probabilities of these events. The result is a measure, related to the information contained in the data set, which the practitioner of this invention can use in any manner where knowledge of this measure is useful. In general, this analytical method treats data as if it were the physical instantiations of informational symbols, even if these outcomes were produced with no intention of creating informational symbols.

It should be noted that the term “informational” is an attribute related to probability, entropy, information, complexity or a similar property. It should be noted the term “symbol,” or “informational symbol” is a thing which represents or means something else. For example, the word “car” represents any kind of physical object which has an engine, transmissions, wheels, etc. It symbolizes an actual, physical thing. I define the physical instantiation of a symbol or informational symbol as the actual occurrences of a symbol. For example, the letters on this piece of paper are instantiated by dark ink on white paper. The physical data which our eyes use to read these letters is the change in light intensities caused by light reflecting off the white paper as well as reflecting off the dark ink of these letters. Finally, it should be noted the term “natural information” is information which is not intentionally created and defined. Examples of intentional information are computer data, Morse code, etc. Examples of natural information are spoken language and written language.

### BRIEF DESCRIPTION OF THE DRAWINGS

FIG. 1 shows an EEG waveform taken from a single electrode which is separated at the peaks and valleys of the waveform and shows how an EEG waveform would be separated into event subsets.

FIG. 2 shows a flow chart for the process of measuring the Tsallis entropy for EEG data taken from the FPz electrode.

### DETAILED DESCRIPTION OF THE INVENTION AND THE PREFERRED EMBODIMENT

The present invention provides a method to measure an informational value; a value related to the information, complexity, entropy or similar measure in a data set or signal. As a necessary background I will briefly discuss the theory of information as formulated by Claude Shannon.

Information theory measures the amount of information in a given signal or other data source. In order to measure the information, Shannon presumed (without saying it) that we have the “dictionary” of meaning for the information symbols. Shannon also assumed that we knew the dictionary which mapped the physical instantiation of an informational symbol to the abstract symbol. This is best illustrated by an example. B, b, b, B, b, are all physical instantiations of the letter “b.” Yet each one is different. We call them letter “b” but they are actually black ink on a white page. Our sensory system knows, without effort, how to interpret them as the letter “b.” Thus, we never think about the relationship between the physical instantiation of a symbol and the symbol itself. In traditional science, such as neuroscience, the question of what is the relationship between a symbol and its meaning is very frequent. However, an equally important question is what is the relationship between physical data and its interpretation as an instantiation of a symbol?

Some examples are given in Table 1:

TABLE 1

| | Symbol | | |
|---|---|---|---|
| Language | (Encoding) | Meaning | Physical Instantiation |
| English | B, b, b, B, b | The | Black ink on white paper. In |
| alphabet | | letter b | terms of reflected light, it is |
| | | | viewed as a high-contrast |
| | | | change from light to dark and |
| | | | back to light. |
| Binary | 10 | The | A constant 5 volts which |
| Computer | | number 2. | suddenly and rapidly |
| | | | plunges to 0 volts. Then |
| | | | the 0 volts holds constant. |
| Morse Code | ... --- ... | S.O.S., | Voltage or sound. The sound |
| (International) | | save our | version is instantiated as air |
| | | ship | vibrations which change in |
| | | | long, then short, then long |
| | | | increments from zero intensity |
| | | | to a relatively high intensity |
| | | | and back to zero. |
| Neural | ? | ? | Neuron produced voltages |
| | | | which exhibit sharp peaks |
| | | | (spikes) at varying times. |

The present invention provides a solution to this problem by three methods. This first method is the result that all information events which are instantiated in physical data begin and end at jumps and/or flat places in the data. Mathematically this is the point where the gradient/derivative of the data is zero (within the resolution of the data):
Δƒ(\overline{r},t)=0 (1.1)

That is, instantiations of implicit or explicit information symbols must begin and end at the point where the gradient (derivative in one dimension; discrete or continuous) is equal to zero. Or where there exists a discontinuity in the data/symbol:

$${lim}_{\vec{r} \to {\vec{r}}_{0}^{+}} ∇ f ( \vec{r} , t ) \neq {lim}_{\vec{r} \to {\vec{r}}_{0}^{-}} ∇ f ( \vec{r} , t ) \qquad ( 1.2 )$$

Here, ƒ is the function which represents the data (or signal).

This appears to be true. For example, the physical instantiations of the ‘dots’ and ‘dashes’ in Morse code begin and end with voltage discontinuities. The same is true in the computer language of zeroes and ones—upswing and downswing discontinuities of the voltage. (One can argue that these are not truly discontinuities, but then we note that the derivative is zero at the beginning of the upswing of the voltage and again zero at the end of this upswing.) Similarly, ‘spike’ events from neurons are conceived as discontinuities. On a closer examination of spike data, they are really data which contain critical points (maxima) at the peak of the spikes.

This also appears to hold true in other modalities which contain information. Consider printed English. The modality is light intensity; bright for the white of the paper and dark for the fonts. Now the beginning and end of each font (and word) is at a discontinuity in the light intensity—a rapid shift from light to dark and vice versa. Restated for clarity, the invention uses the approach of identifying informational events in data by partitioning the data at a plurality of the jumps and flat points (which often occur at peaks, valleys and saddle points). Mathematically, the gradient equals zero or is not defined in the data. We will call these partitioned data sets, “event subsets.”

A second difficulty is how to use event subsets to compute an informational measure. We might be tempted to assume that all event subsets which contain the same data correspond to the same events; otherwise, they are different events. But this assumes that the mapping between the physical data and the information symbol which it represents is one-to-one. This is generally not true. A simple example is spoken English. Suppose we recorded the sound intensity and frequency of the spoken word, “hello,” ten times. All ten recordings would be different. Using the one-to-one assumption, we would decide that we were dealing with ten different information symbols. And we would be wrong.

A second method solves this difficult problem. This method is based on the fact that there is a relationship between the amount of information (or other informational measure) represented by a symbol and its specific instantiation as physical data. Moreover, this relationship is “absolute.” Here, “absolute” means that this relationship is in some sense directly related to the data contained by an event subset and not a product of how these data relate to the data in other event subsets. For example, in printed language there is a relationship between the area (more exactly, the area squared) contained in a symbol, e.g., letter, the length of its perimeter, and the symbol's probability of occurring (within the context of the proceeding symbols; probability is related to information.) For example, a very frequent symbol is the period, “.” Its probability is especially high when it is conditioned on the occurrence of a previous series of words, that is, a sentence. Mathematically, the most area that a closed line can encompass is a circular shape; a disk. Thus, the area of a period, divided by its circumference will yield a very high ratio. Similarly, many high frequency letters have circular shapes: a, e and o. On the other hand, infrequent letters have elongated shapes which yield a relatively low ratio of area to perimeter length. An “X” has a very long perimeter compared to its area. X, of course, is a very infrequent letter.

This is the essence of the present invention, identifying information events in data by partitioning the data at flat points/peaks/valleys/saddle points or jumps, and computing an informational measure for each of these informational events by computing a measure which is directly based on the physical instantiation of a symbol. This brings us to a third method: treating data which contains information as data which implicitly or explicitly represents instantiations of informational symbols. An example of an explicit representation would be printed English. An example of an implicit representation would be the voltage record of brain waves, the electroencephalogram or “EEG.”

Operation—An Application for One Dimensional Data

Let a vector, \overline{x}ᵢ represent the outcome of a single physical instantiation of an informational symbol, where nᵢ is the number of data points. In many cases, this outcome is substantially related to its probability:

$${p}_{i} ≃ K \frac{{\sum }_{j = 1}^{{n}_{i}} {( {x}_{ij} - {\overline{x}}_{i} )}^{2}}{{n}_{i}} \qquad ( 1.3 )$$

where xᵢⱼ is the jth data point in the vector \vec{x}ᵢ, \overline{x}ᵢ is the mean value of all elements of \vec{x}ᵢ, and pᵢ is the event probability and K is a constant. Again, please note that the vector \vec{x}ᵢ represents the event subset which contains the data that represents the physical instantiation of an informational symbol.

Note that this is the one-dimensional analog of the earlier example where we discussed the probability of a particular letter occurring. In the present case, we divide by the length, nᵢ which is the one-dimensional analog of dividing by the length of the perimeter. Similarly we compute the gradual changes in the event's continuous data in a manner analogous to computing the area (or area squared) of a letter. In the latter case, changes are discrete. The data changes in accordance with the jump from light paper to dark ink, a change marked by a discontinuity in the data. Thus, the probability of the event is fully dependent on the physical instantiation of the particular event (except for a constant).

Often the constant K is substantially related to the inverse of the variance of the events. This is estimated as:

$$1 / K ≃ Var [ \vec{x} ] ≃ \frac{1}{M \overline{n}} {\sum }_{m = 1}^{M \overline{n}} {( {x}_{mj} - \overline{x} )}^{2} \qquad ( 1.4 )$$

Here, Var is the variance, \overline{n} is the average length of an event, \vec{x} is the random variable vector representing a particular physical instantiation of a informational symbol and m is the mth outcome of the empirical data, M is the total number of informational event outcomes in the data, which means that M\overline{n} is the total number of data points, and \vec{x} is the total mean of all outcomes of the vector elements, which have been identified by partitioning the data at maxima/minima/saddle points and discontinuities/jumps. Thus, this is a standard estimation of the variance. This means the estimate, \hat{p}ᵢ of the probability of a single event is substantially related to:

$${\hat{p}}_{i} ≃ \frac{\frac{1}{{n}_{i}} {\sum }_{j = 1}^{{n}_{i}} {( {x}_{ij} - {\overline{x}}_{i} )}^{2}}{\frac{1}{M \overline{n}} {\sum }_{m = 1}^{M \overline{n}} {( {x}_{mj} - \overline{x} )}^{2}} \approx \frac{{\sum }_{j = 1}^{{n}_{i}} {( {x}_{ij} - {\overline{x}}_{i} )}^{2}}{\frac{1}{M} {\sum }_{m = 1}^{M \overline{n}} {( {x}_{mj} - \overline{x} )}^{2}} \qquad ( 1.5 )$$

Here, we have used the approximation nᵢ≈\overline{n}. Now assume that we sum over the variability of each individual outcome and divide by the sum of the variability of all outcomes:

$$\frac{{\sum }_{m = 1}^{M} {\sum }_{j = 1}^{{n}_{i}} {( {x}_{mj} - {\overline{x}}_{m} )}^{2}}{{\sum }_{m = 1}^{M \overline{n}} {( {x}_{mj} - \overline{x} )}^{2}} = \frac{{\sum }_{i = 1}^{N} {M}_{i} ( {\sum }_{j = 1}^{{n}_{i}} {( {x}_{ij} - {\overline{x}}_{i} )}^{2} )}{\frac{M}{M} {\sum }_{m = 1}^{M \overline{n}} {( {x}_{mj} - \overline{x} )}^{2}} \qquad ( 1.6 )$$

where Mᵢ is the number of instantiations of the ith informational symbol. Now,

$$\frac{{M}_{i}}{M} ≡ {\tilde{p}}_{i}$$

is a second estimator for the probability of the ith event. Rewriting 1.6:

$$\frac{{\sum }_{i = 1}^{N} \frac{{M}_{i}}{M} ( {\sum }_{j = 1}^{{n}_{i}} {( {x}_{ij} - {\overline{x}}_{i} )}^{2} )}{\frac{1}{M} {\sum }_{m = 1}^{M \overline{n}} {( {x}_{mj} - \overline{x} )}^{2}} ≃ {\sum }_{i = 1}^{N} {\tilde{p}}_{i} {\hat{p}}_{i} = {\sum }_{i = 1}^{N} {{p}^{⋒}}_{i}^{2} \qquad ( 1.7 )$$

Here, \hat{p}ᵢ² is an estimator for the probability squared. Eq. 1.7 can easily be used to estimate an informational value such as the Tsallis information for an exponent of 2:

$${H}_{T} ( \vec{x} ) = k ( 1 - {\sum }_{i = 1}^{N} {p}_{i}^{2} ) ≃ k ( 1 - \frac{{\sum }_{m = 1}^{M} {\sum }_{j = 1}^{{n}_{i}} {( {x}_{mj} - {\overline{x}}_{m} )}^{2}}{{\sum }_{m = 1}^{M \overline{n}} {( {x}_{mj} - \overline{x} )}^{2}} ) \qquad ( 1.8 )$$

Here, H_{T} is the Tsallis information and k>0 is an arbitrary constant. This is approximate to a more exact estimator:

$${H}_{T} ( \vec{x} ) = k ( 1 - {\sum }_{i = 1}^{N} {p}_{i}^{2} ) ≃ k ( 1 - \frac{{\sum }_{m = 1}^{M} \frac{1}{{n}_{i}} {\sum }_{j = 1}^{{n}_{i}} {( {x}_{mj} - {\overline{x}}_{m} )}^{2}}{\frac{1}{\overline{n}} {\sum }_{m = 1}^{M \overline{n}} {( {x}_{mj} - \overline{x} )}^{2}} ) \qquad ( 1.9 )$$

Here, we have not used the approximation nᵢ≈\overline{n}. Thus, the result estimates the sum of the probabilities squared of a number of informational events without any explicit frequency counting. In fact, we don't even attempt to distinguish between the same and different informational events. Instead, this value comes from an analysis of the event subsets which represents physical instantiations of informational events.

### Operation—An Application for Multi-Dimensional Data

The multivariable version of this estimation is done in a substantially similar manner. The data is partitioned where the gradient or its discrete estimator is substantially zero, or discontinuous.

### Operation—Preferred Embodiment

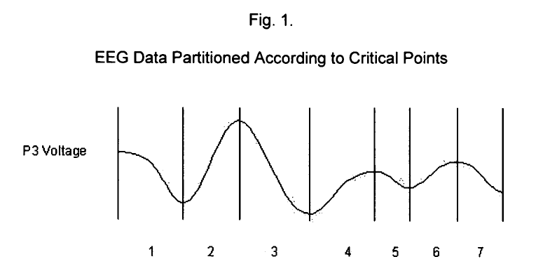

We will use the method on the one dimensional data of the EEG. Here, the data is in millivolts. An example of the partitioning data in accordance with their maxima, minima and saddle points—that is, their critical points are diagrammed in FIG. 1.

After partitioning said voltage data into data sets, we would subtract the mean of each set from each value. Then we would multiply each of these values by it's self and add them up to form a first sum. We would do this for each data set and then add up all the values. We would then subtract the total mean from all values. We would multiply each of these new values by it's self and add them up to form a second sum. We would divide the first sum by the second sum. This value would be subtracted form one. If we choose, we can multiply this value by a constant.

### Operation—Additional Embodiment

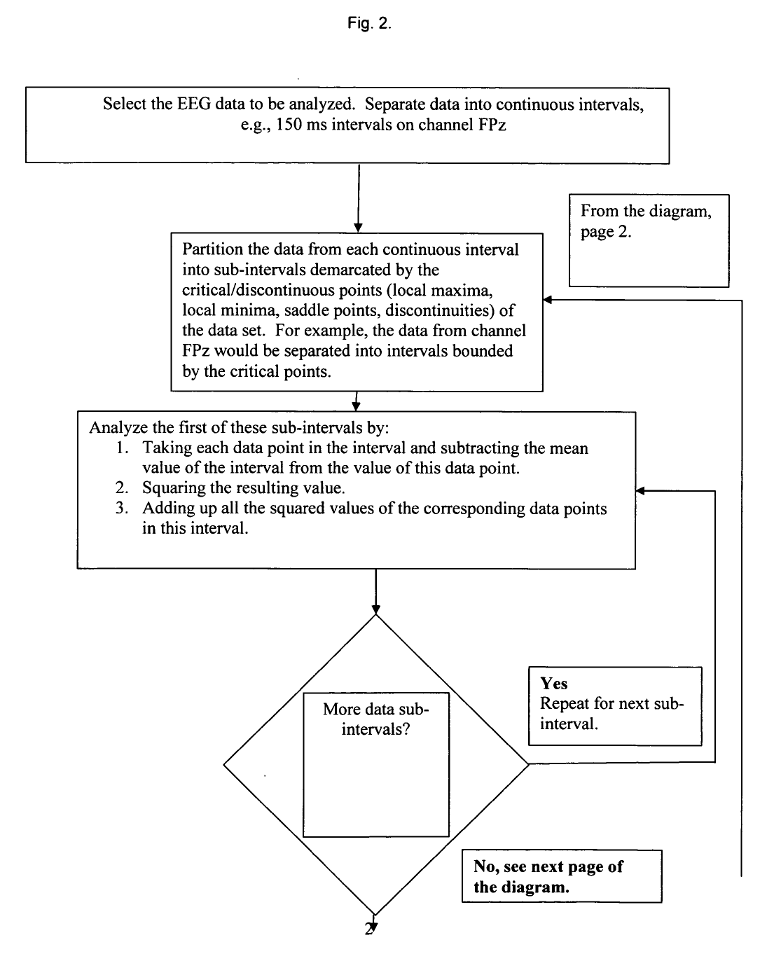

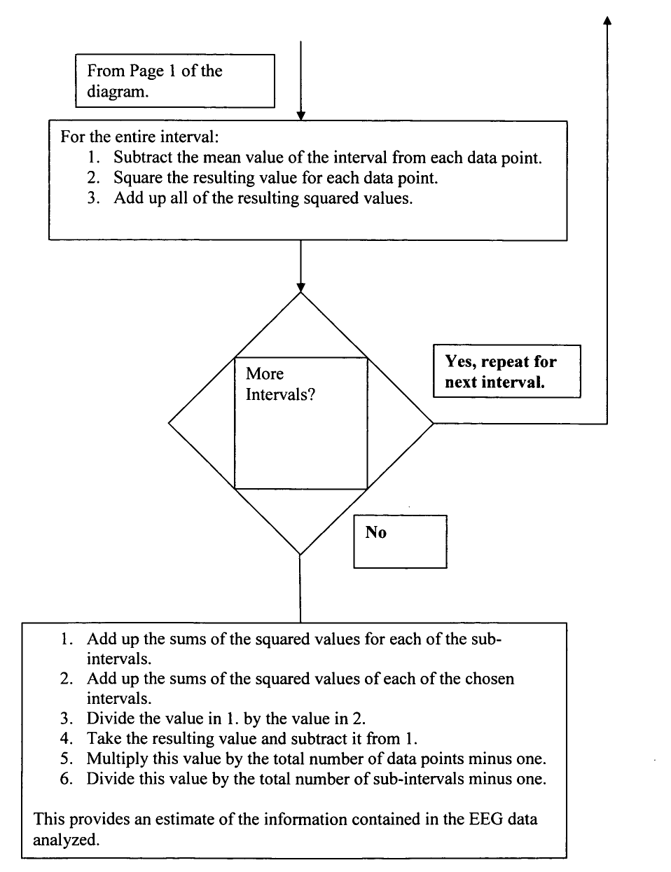

This is a method for quantifying information and/or computation which can measure information when the information representation is undefined. See FIG. 2 for a diagram of this method.

Here, the user can, but does not have to, define what data or other entity to be measured. This method can use but does not have to use and is not limited to; electroencephalography (EEG) data, stock market data, and other financial data including but not limited to securities, functional Magnetic Resonance Imaging, Computer Aided Tomography, SPECT, PET etc. Combined uses of these data are also possible.

Possible uses of this method include, but are not limited to, measuring brain information flow, measuring the effectiveness of medical treatment; medical diagnosis, detection, and monitoring.

This method can measure data change, in a normalized fashion, to quantify/approximate information amounts. This method may quantify change via statistical measures such as variance, kurtosis and/or skew in optimally and/or appropriately partitioned data. This partitioning of said data, may, but does not have to, be in accordance with the maxima, minima, saddle points and/or discontinuities of said data. It may also be chosen from knowledge of the nature of the information representation, i.e., partitioning at the beginning and end of events, or some combination of this knowledge and the partitioning of the data via maxima, minima, saddle points and/or discontinuities. Normalization of said quantified changes can be the total measure of change in a given data interval or the total data set. It can also be done via a total measure of change taken from knowledge of the type of events in the information or some combination of this knowledge and the total measure of change in the given data interval or the total data set.

### Method One

1. This method estimates information, where the estimate is based on some information representation or information-like representation such as the Shannon self-information “entropy,” mutual information including the mutual information between the past and future as defined in the data, etc. It may be an approximation thereof. The method is applicable to measuring information in all cases but especially applicable when knowledge of the representation of the information i.e., the “code” or alphabet is partially or wholly unknown.
a. An estimated information amount occurs when the approximate information is computed from normalized changes such that the equation is approximately equivalent to an appropriate information measure. This appropriate measure can, but does not have to be the Shannon self-information measure, mutual information or other information or information-like measure.
b. Computation/change of information measurement occurs by comparing information values for different data sets. This comparison can, but does not have to include ratios or differences. It can be done with a suitably chosen metric where such metric measures change. It can also be done in a qualitative fashion such that the chosen qualities denote change in the information and/or representation and/or computational change.

### Method Two

2. This method can compute information flow and/or change a. Information flow can be quantified/estimated/represented by examining the change in the measure over time and/or space.
b. Computation can be quantified/estimated/represented by examining the change in the measure over time and/or space.

Whereas the present invention has been described in particular relation to the drawings attached hereto, it should be understood that other and further modifications apart from those shown or suggested herein, may be made within the scope and spirit of the present invention. The above examples are not mutually exclusive, nor are they to be considered exhaustive. A user of said method might, but is not limited to, combining portions of any or all of the above.

1. A method for measuring an informational value:
a. by dividing the data set into a plurality of data subsets at or substantially near a plurality of the places where the change in the data is zero or substantially close to zero or where the change in the data is substantially discontinuous
b. computing or estimating an attribute for each of a plurality of these data subsets in a manner which is substantially dependent on a plurality of the data contained in each subset
c. aggregating said values over a plurality of the data subsets to compute a total informational value

2. The method of claim 0 where said data set has a resolution equal to or greater than the resolution of the signal which contains said data

3. The method of claim 0 where said attribute is substantially the same as the variability of the data in each data subset

4. The method of claim 0 where said aggregation is substantially based on summing the variability of each data subset and dividing it by the variability of all the data

5. The method of claim 0 where the value computed is subtracted from a constant so that it is substantially similar to an estimator of the Tsallis entropy

6. The method of claim 0 where the data is electroencephalography (EEG) data and these data are divided at the maxima, minima and saddle-points of said data

7. A method for estimating informational values which:
a. treats data as being substantially related to a plurality of physical instantiations of informational symbols
b. measures an informational property for a plurality of these physical instantiations by using physical attributes of a plurality of the data representing each instantiation

8. The method of claim 0 which aggregates said informational property measures over a plurality of the physical informational symbol instantiations to compute an aggregate informational measure

9. The method of claim 0 where said data is not the product of the physical instantiations of intentionally designed human information symbols

10. The method of claim 0 where an informational value is estimated for each of a plurality of the physical instantiations and each value is substantially based on changes in the data which represent each physical instantiation

11. The method of claim 0 where an informational value for a plurality of the data is measured by aggregating said informational values for a plurality of each physical instantiation

12. The method of claim 0 where said aggregation is substantially based on a summation of said informational values for a plurality of each physical instantiation

13. The method of claim 1 where it is applied to a signal.

14. The method of claim 0 where said data set has a resolution equal to or greater than the resolution of the data by the normal receiver of the signal which contains said data

15. The method of claim 1 where it is used for data mining

16. The method of claim 1 where it is applied with corrections for data noise

17. The method of claim 1 where it is applied to economic data or financial data

18. The method of claim 1 where it is applied to with corrections for incomplete data

19. The method of treating data and signals which are not the product of intentionally designed human information symbols as the physical instantiations of informational symbols.

20. The method of claim 19 which defines a natural language from said physical instantiations
